(19) United States
(12) Patent Application Publication
(10) Pub. No.: US 2009/0158149 A1
(43) Pub. Date: Jun. 18, 2009

(54) MENU CONTROL SYSTEM AND METHOD

(75) Inventor: Ju-Hyun KO, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/186,842

(22) Filed: Aug. 6, 2008

(30) Foreign Application Priority Data
Dec. 18, 2007 (KR) 10-2007-0133465

(51) Int. Cl. G06F 3/041

(52) U.S. Cl. 715/702

(57) ABSTRACT

A menu control system and method that to control functions of a digital device are provided. The menu control system includes a detection unit which detects a first sub-contact area and a second sub-contact area within a contact area, the contact area generating a signal through contact with an object if the object is dragged from the first sub-contact area to the second sub-contact area, and an execution unit which executes a function mapped to a combination of the detected first sub-contact area and second sub-contact area.

### CROSS-REFERENCE TO RELATED APPLICATION

This application is based on and claims priority from Korean Patent Application No. 10-2007-0133465, filed on Dec. 18, 2007, in the Korean Intellectual Property Office, the disclosure of which is incorporated herein in its entirety by reference.

### BACKGROUND OF THE INVENTION

1. Field of the Invention

Methods and systems consistent with the present invention relate to a menu control system and method, and, more particularly, to a menu control system and method that can control functions related to playback of multimedia content more easily.

2. Description of the Prior Art

Recently, with the development of digital technology, there is an increasing demand for digital devices. Digital devices are devices that include circuits capable of processing digital data, and include a digital TV, a personal digital assistant (PDA), a portable phone, and so forth. Such digital devices include various kinds of software mounted thereon to play multimedia content, and enable users to view and/or listen to the multimedia data.

However, the related art digital device is not user friendly. For example, in order to adjust the volume while a user views and/or listens to multimedia content through a digital device, the user must request a menu related to volume adjustment, adjust the volume on a displayed menu, and then remove the displayed menu from the screen. This control process not only causes user inconvenience but also temporarily disturbs the viewing of the multimedia content.

In addition, since it is difficult to provide a portable device such as a PDA or a portable phone with a large number of control buttons, it is difficult to control various functions of the portable device using a limited number of control buttons.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present invention is to provide a menu control system and method that can easily control functions of a digital device.

However, the aspects, features and advantages of the present invention are not restricted to the ones set forth herein. The above and other aspects, features and advantages of the present invention will become more apparent to one of ordinary skill in the art to which the present invention pertains by referencing a detailed description of the present invention given below.

According to an aspect of the present invention, there is provided a menu control system, comprising a detection unit which detects a first sub-contact area and a second sub-contact area within a contact area for generating a signal through contact with an object if the object is dragged from the first sub-contact area to the second sub-contact area; and an execution unit which executes a function mapping on a combination of the detected first sub-contact area and second sub-contact area.

In another aspect of the present invention, there is provided a menu control system comprising a detection unit which detects a first sub-contact area and a second sub-contact area within a contact area for generating a signal through contact with an object if the object is dragged from the first sub-contact area to the second sub-contact area; and a communication unit which provides a command corresponding to a combination of the detected first sub-contact area and second sub-contact area to a digital device.

In still another aspect of the present invention, there is provided a menu control system comprising: a communication unit which receives a command mapping on a combination of a first sub-contact area and a second sub-contact area within a contact area for generating a signal through contact with an object if the object is dragged from the first sub-contact area to the second sub-contact area; and an execution unit which executes a function corresponding to the received command.

In still another aspect of the present invention, there is provided a menu control method comprising: detecting a first sub-contact area and a second sub-contact area within a contact area for generating a signal through contact with an object if the object is dragged from the first sub-contact area to the second sub-contact area; and executing a function mapping on a combination of the detected first sub-contact area and second sub-contact area.

In still another aspect of the present invention, there is provided a menu control method comprising detecting a first sub-contact area and a second sub-contact area within a contact area for generating a signal through contact with an object if the object is dragged from the first sub-contact area to the second sub-contact area; and providing a command corresponding to a combination of the detected first sub-contact area and second sub-contact area to a digital device.

In still another aspect of the present invention, there is provided a menu control method comprising receiving a command mapping on a combination of a first sub-contact area and a second sub-contact area within a contact area for generating a signal through contact with an object if the object is dragged from the first sub-contact area to the second sub-contact area; and executing a function corresponding to the received command.

### BRIEF DESCRIPTION OF THE DRAWINGS

The above and other aspects of the present invention will be apparent from the following detailed description taken in conjunction with the accompanying drawings, in which:

FIG. 1 is a block diagram illustrating the construction of a menu control system according to an exemplary embodiment of the present invention;

FIG. 2 is an exemplary view showing a contact area which has been divided into two sub-contact areas according to an exemplary embodiment of the present invention;

FIG. 3 is an exemplary view showing a contact area which has been divided into five sub-contact areas according to an exemplary embodiment of the present invention;

FIG. 4 is an exemplary view showing a contact area which has been divided into four sub-contact areas according to an exemplary embodiment of the present invention;

FIG. 5 is an exemplary view showing a mapping table describing the divided sub-contact areas as shown in FIG. 4 according to an exemplary embodiment of the present invention;

FIG. 6 is an exemplary view showing a display area in which a graphical user interface of a function, which is executed according to a combination of a drag start area and a drag end area, is displayed according to an exemplary embodiment of the present invention;

FIG. 7 is an exemplary view showing a display area in which guide information of functions, which can be executed in combination with a drag start area, is displayed according to an exemplary embodiment of the present invention;

FIG. 8 is a view schematically illustrating an input unit and a display unit physically implemented in one module;

FIG. 9 is an exemplary view showing a contact area on which boundary lines of respective sub-contact areas are drawn according to an exemplary embodiment of the present invention;

FIG. 10 is an exemplary view showing a contact area on which projections are formed along boundaries of respective sub-contact areas according to an exemplary embodiment of the present invention; and

FIG. 11 is a flowchart illustrating a menu control method according to an exemplary embodiment of the present invention.

### DETAILED DESCRIPTION OF THE PREFERRED EMBODIMENTS

Advantages and features of the present invention and methods of accomplishing the same may be understood more readily by reference to the following detailed description of exemplary embodiments and the accompanying drawings. The present invention may, however, be exemplarily embodied in many different forms and should not be construed as being limited to the embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention is described hereinafter with reference to flowchart illustrations of user interfaces, methods, and computer program products according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded into a computer or other programmable data processing apparatus to cause a series of operational steps to be performed in the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

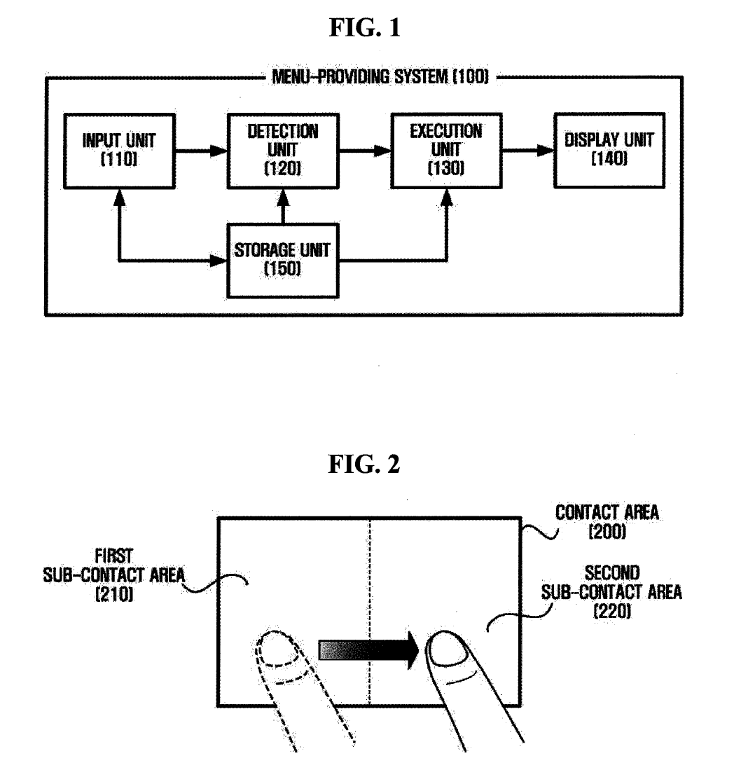

FIG. 1 is a block diagram illustrating the construction of a menu control system according to an exemplary embodiment of the present invention.

As illustrated in FIG. 1, the menu control system 100 according to an exemplary embodiment of the present invention includes an input unit 110, a storage unit 150, a detection unit 120, an execution unit 130, and a display unit 140.

The input unit 110 receives an input of a user command related to playback of multimedia content. Multimedia content (hereinafter referred to as “content”) means a digital object including at least one of video information, audio information, and text information. Content may be types of moving images, images, music, Java games, electronic books, and various kinds of digital broadcasts (e.g., digital multimedia broadcasts, digital video broadcasts, digital audio broadcasts, and so forth).

In contrast, the term “playback” used in the exemplary embodiments of present invention means a visual or audio reproduction of content so that a user can use the content. Content playback may include “play”, “display”, “execute”, “print”, and so forth.” “Play” means expressing content in the form of audio or video. For example, if the content is related to a moving image or music, the content playback may be “play”. Also, “display” means an expression of content on a visual device, and “print” means generation of a hard copy of content. For example, if the content is related to an image, the content playback may be at least one of “display” and “print”. In addition, “execute” means the use of content in the form of a game or other application programs. For example, if the content is related to a Java game, the content playback may be “execute”.

User commands related to the content playback may be a channel increase command, a channel decrease command, a volume increase command, a volume decrease command, a command for increasing a playback speed, a command for decreasing a playback speed, a command for increasing the brightness of a screen, a command for decreasing the brightness of a screen, a command for moving a cursor up/down/left/right, a command for moving a scroll upward/downward, a command for selecting the previous content, a command for selecting the next content, a command for selecting a file to be played, and so forth.

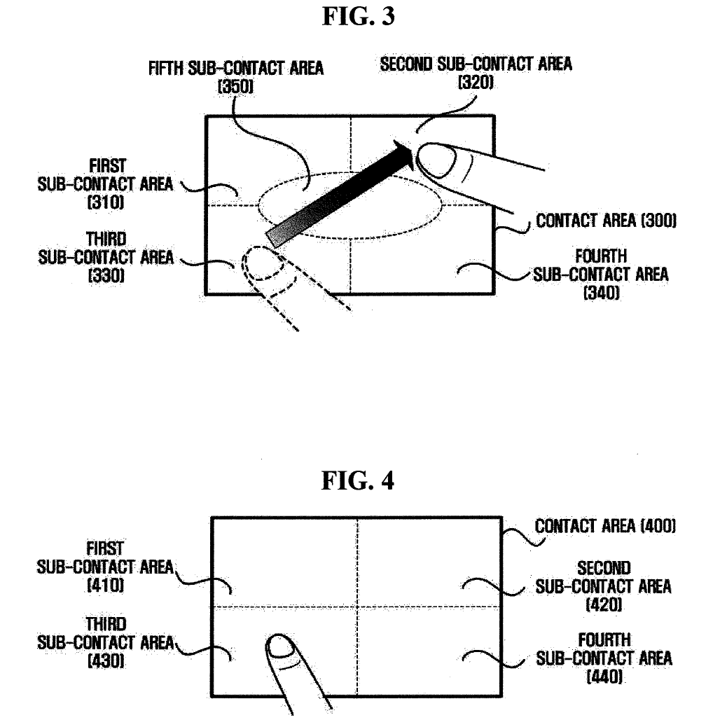

The input unit 110 may include a contact area for generating a signal through contact with an object. The contact area, as shown in FIGS. 2 to 4, may be divided into a plurality of sub-contact areas. FIG. 2 shows a contact area 200 which has been divided into two sub-contact areas 210 and 220, and FIG. 3 shows a contact area 300 which has been divided into five sub-contact areas 310, 320, 330, 340, and 350. FIG. 4 shows a contact area 400 which has been divided into four sub-contact areas 410, 420, 430, and 440.

When a contact area has been divided into a plurality of sub-contact areas as described above, a user can input one of the above-described commands by clicking a specified sub-contact area or moving an object to another sub-contact area in a state where the object is in contact with the specified sub-contact area. For example, if the divided sub-contact areas are as shown in FIG. 2, the user can increase the playback speed of content being played in a forward direction by clicking the first sub-contact area 210. Also, the user can increase the playback speed of the content being played in a forward direction by moving a finger to the second sub-contact area 220 from the first sub-contact area 220. In contrast, in order to increase the playback speed of the content being played in a backward direction, the user moves a finger to the first sub-contact area 210 from the second sub-contact area 220.

If the divided sub-contact areas are as shown in FIG. 3, the user can input a command related to the content playback by moving his/her finger to a sub-contact area 310 or 340, which is located vertically relative to the third sub-contact area 330, or to a sub-contact area 320 or 350, which is located diagonally relative to the third sub-contact area 330, in a state where a finger is in contact with the third sub-contact area 330. In another exemplary embodiment of the present invention, the fifth sub-contact area 350 may not generate a contact signal through contact with the object unlike other sub-contact areas 310, 320, 330, and 340.

As described above, the contact area has been described with reference to FIGS. 2 to 4, but the shapes of the divided sub-contact areas are not limited to the exemplary embodiments shown in the drawings. In the following description, the case where the contact area has been divided into four sub-contact areas 410, 420, 430, and 440, as shown in FIG. 4, will be described as an example. In addition, the movement of an object to another sub-contact area in a state where the object is in contact with a specified sub-contact area will be called “drag”. Also, a sub-contact area in which a drag starts will be called a “drag start area”, and a sub-contact area in which the drag is completed will be called a “drag end area”.

Referring to FIG. 1, the display unit 140 has a display area in which results of command processes are displayed. The display area may be divided into a plurality of sub-display areas to correspond to the contact areas of the input unit 110. This display unit 140, for example, may be implemented by an LCD (Liquid Crystal Display), but is not limited thereto.

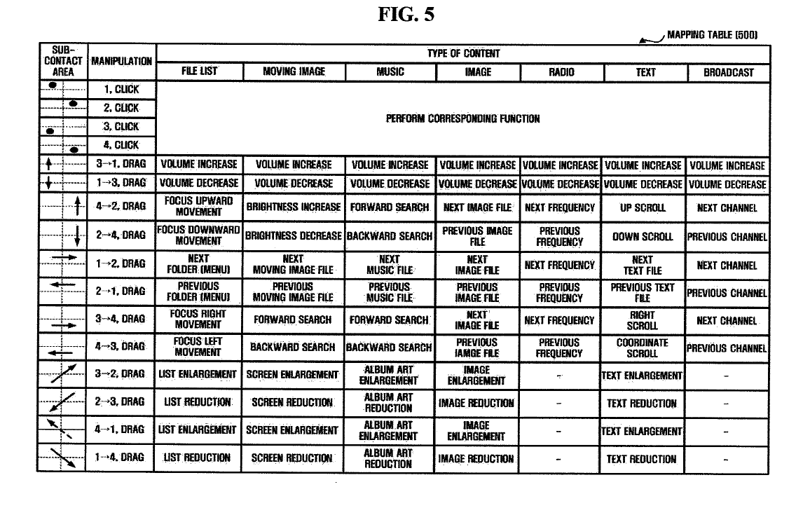

The storage unit 150 stores therein mapping information between user manipulations and functions related to content playback. Here, the user manipulation may be a clicking of the respective sub-contact areas or a dragging of an object from the drag start area to the drag end area. Alternatively, a user manipulation can map various functions in accordance with the type of content. The mapping information, as shown in FIG. 5, can be stored in the form of a mapping table 500. The mapping table 500 will be described in more detail with reference to FIG. 5.

FIG. 5 is an exemplary view showing a mapping table 500 describing the divided sub-contact areas 410, 420, 430, and 440 as shown in FIG. 4 according to an exemplary embodiment of the present invention.

Referring to FIG. 5, if a specified sub-contact area is clicked, functions mapped to the clicked sub-contact area is executed.

If an object is dragged to the third sub-contact area 430 from a state where the object is in contact with the first sub-contact area 410, this manipulation maps on a function of decreasing the volume of content being played. In contrast, if the object is dragged to the first sub-contact area 410 from a state where the object is in contact with the third sub-contact area 430, the user manipulation maps to a function for increasing the volume of the content being played. As described above, one user manipulation may map on one function irrespective of the kind of the content, or may map on a plurality of functions in accordance with the kind of the content being played.

In the case of a user manipulation to drag the object to the second sub-contact area 420 from a state where the object is in contact with the first sub-contact area 410, the user manipulation maps to playback of the next folder (i.e., menu), playback of the next moving image file, playback of the next music file, playback of the next photo file, change to the next frequency, playback of the next text file, change to the next channel, and so forth, in accordance with the type of content.

In the case where one user manipulation maps to a plurality of functions as described above, the function selected in accordance with the type of content is executed.

If the kind of the content being played is a file list, and the object is dragged to the fourth sub-contact area 440 from a state where the object is in contact with the second sub-contact area 420, a function of moving the position of a focus downward may be performed. If the content being played is a moving image, a function of decreasing the brightness of the screen may be performed. If the content being played is a text file, a function of moving a scroll being displayed on the screen downward may be performed.

In addition to the mapping table 500, the storage unit 150 stores information on the contact area 400. The information on the contact area 400 may be an area of the contact area 400, a number of sub-contact areas included in the contact area 400, coordinates corresponding to boundaries of the respective sub-contact areas, and so forth. The number of sub-contact areas included in the contact area 400 may be designated in advance, or may be determined by the user. If the number of sub-contact areas is changed by the user, the coordinate information included at boundaries of the respective sub-contact areas may also be updated in accordance with the contents of the change. The storage unit 150 may be implemented by at least one of a nonvolatile memory device, such as a cache, a ROM, a PROM, an EPROM, an EEPROM, and a flash memory, and a volatile memory device such as a RAM, but is not limited thereto.

The detection unit 120 detects the drag start area and the drag end area in the contact area 400 with reference to the pre-stored information. In order to detect the drag start area and the drag end area, the detection unit 120 can determine whether the object is in contact with the contact area 400, whether a drag has started, whether a drag has ended, and whether a contact of an object with the contact area 400 has been released.

Specifically, the detection unit 120 determines whether the object is in contact with the contact area 400. If the object is in contact with the contact area 400 as a result of determination, the detection unit 120 can detect the sub-contact area including a point which the object is in contact with as the drag start area. The result of detection is provided to the execution unit 130 (described later).

Then, the detection unit 120 determines whether the drag of the object has begun. That is, the detection unit 120 can determine whether the object is kept unmoved or is moving in a state that the object is in contact with the contact area 400.

If the drag of the object is determined to have begun, the detection unit 120 determines whether the drag is completed. That is, the detection unit 120 determines whether the object stops moving.

If the drag of the object is completed as a result of determination, the detection unit 120 determines whether the contact of the object with the contact area 400 is released. That is, the detection unit 120 determines whether the contact state between the object and the contact area 400 is maintained at a point where the movement of the object is stopped.

If the contact of the object with the contact area is released as a result of determination, the detection unit 120 detects the sub-contact area including the point where the contact of the object with the contact area is released as the drag end area. The result of detection is provided to the execution unit 130 to be described later.

If the contact of the object with the contact area is not released as a result of determination, the detection unit 120 detects the sub-contact area including the point which the object is in contact with as the drag end area. Then, the detection unit 120 detects a time period when the contact state between the object and the drag end area is maintained. The result of detection performed by the detection unit 120 is provided to the execution unit 130 to be described later.

The execution unit 130 executes a command corresponding to a combination of the drag start area and the drag end area with reference to the pre-stored mapping table 500. For example, it is assumed that the divided contact area 400 is as shown in FIG. 4 and the mapping table 500 is as shown in FIG. 5. If the first sub-contact area 410 is the drag start area and the third sub-contact area 430 is the drag end area, the execution unit 130 decreases the volume of the content being played.

If a plurality of functions correspond to the combination as a result of referring to the mapping table 500, the execution unit 130 executes the function selected based on the type of content being currently played. For example, if the second sub-contact area 40 is the drag start area and the fourth sub-contact area 440 is the drag end area, and the content being currently played is a moving image, the screen brightness is decreased. If the content being currently played is a text, the position of a scroll is moved downward on the screen.

The function corresponding to the combination of the drag start area and the drag end area may be executed in various methods. Specifically, the execution unit 130 may change the execution state of the corresponding function as much as a predetermined execution range whenever the object is dragged. For example, if it is assumed that the dragging of the object to the fourth sub-contact area 440 in a state that the object is in contact with the second sub-contact area 420 and the release of the contact state constitute one operation, the execution unit 130 may decrease the brightness of the screen by 1 whenever the operation is once performed.

Further, the execution unit 130 may determine the execution range in proportion to the dragging speed of the object, and may change the execution state of the corresponding function as much as the determined range. For example, if the dragging speed of the object that is dragged to the fourth sub-contact area 440 in a state that the object is in contact with the second sub-contact area 420 is 2 cm/s, the execution unit 130 decreases the brightness of the screen by 2. If the dragging speed of the object is 5 (cm/s), the execution unit decreases the brightness of the screen by 5. In this case, the dragging speed of the object is detected by the detection unit 120.

If the object is dragged to the drag end area and is kept in contact with the contact area 400, the execution unit 130 may further change the execution state of the corresponding function as much as the determined execution range in accordance with the time period when the object is kept in contact with the drag end area. For example, if the object is dragged from the second sub-contact area 420 to the fourth sub-contact area 440, and then is kept in the contact state for 2 seconds, the execution unit decreases the brightness of the screen by 1, and then further decreases the brightness of the screen by 2. If the object is kept in the contact state for 4 seconds after being dragged, the execution unit 130 further decreases the brightness of the screen by 4.

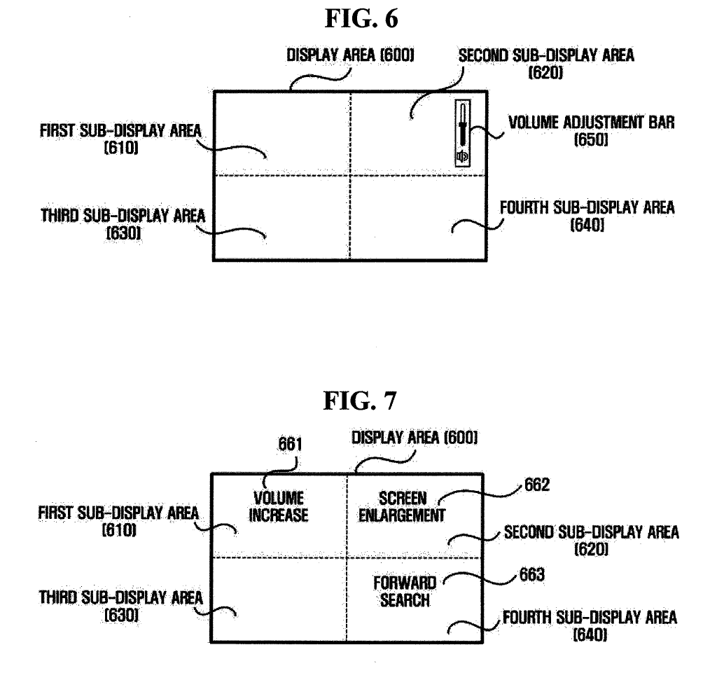

In contrast, the execution unit 130 may display a graphical user interface indicating the execution state of the function that is executed by a combination of the drag start area and the drag end area through a display area. For example, as shown in FIG. 4, as the object is dragged from the third sub-contact area 430 to the first sub-contact area 410, the execution unit 130 may display a volume adjustment bar in the display area. In this case, the volume adjustment bar may be displayed on the sub-display area corresponding to the sub-contact area except for the drag start area. For example, the volume adjustment bar may be displayed on any one of a first sub-display area corresponding to the first sub-contact area 410, a second sub-display area corresponding to the second sub-contact area 420, and a fourth sub-display area corresponding to the fourth sub-contact area 440. FIG. 6 shows a volume adjustment bar 650 displayed on the second sub-display area 620.

In addition, the execution unit 130, if the drag start area is detected, displays guide information of functions that can be executed in combination with the drag start area on a sub-display area 600 corresponding to a reserve drag end area. Here, the reserve drag end area means a sub-contact area that can be detected as the drag end area. For example, as illustrated in FIG. 4, if the object is in contact with the third sub-contact area, the first sub-contact area 410, the second sub-contact area 420, and the fourth sub-contact area 440 may be the reserve drag end area. In this case, the execution unit 130 can display the guide information of functions executable by a combination of the drag start area and the drag end area, i.e., a volume increase 661, a screen enlargement 662, fast forward playback 663, and so forth, on the first sub-display area 610, the second sub-display area 620, and the fourth sub-display area 640, respectively, as shown in FIG. 7, with reference to the mapping table 500 as illustrated in FIG. 5.

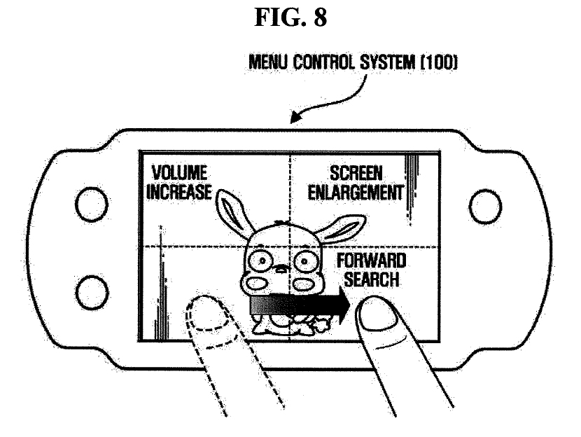

In the menu control system 100 as described above, the input unit 110 and the display unit 140 may be physically implemented in a module. For example, the input unit 110 and the display unit 140 may be implemented by a touch screen. In this case, the contact area 400 of the input unit 110 and the display area 600 of the display unit 140 may coincide with each other. FIG. 8 shows the contact area 400 and the display area 600 which coincide with each other.

In another embodiment of the present invention, the input unit 110 and the display unit 140 may be physically implemented in different modules. For example, the input unit 110 is implemented by a touch pad, and the display unit 140 may be implemented by an LCD. In this case, the contact area 400 of the input unit 110 and the display area 600 of the display unit 140 may or may not coincide with each other. The fact that the contact area 400 and the display area 600 do not coincide with each other means that at least one of the total area and the shape of the contact area 400 and the display area 600 may differ. For example, the contact area 400 may be elliptical and the display area 600 may be rectangular. Also, the contact area 400 and the display area 600 may have the same shape, but the total area of the contact area may be smaller than that of the display area 600.

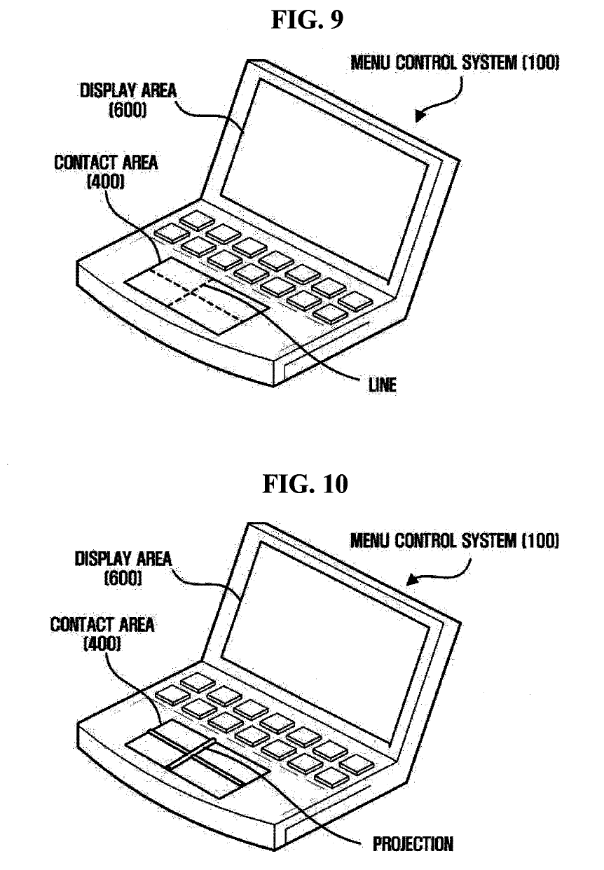

In the case where the input unit 110 and the display unit 140 are implemented in different modules as described above, boundaries of the respective sub-contact areas may be marked on the surface of the contact area 400. In this case, the boundaries of the respective sub-contact areas, for example, may be marked by lines or projections. FIG. 9 shows the contact area 400 on which boundary lines of respective sub-contact areas are drawn, and FIG. 10 shows the contact area 400 on which projections are formed along boundaries of respective sub-contact areas. In the case of the contact area 400 as shown in FIG. 9, the user can visually confirm the boundaries of the respective sub-contact areas, while in the case of the contact area 400 as shown in FIG. 10, the user can confirm the boundaries of the respective sub-contact areas by a tactile sensation.

In contrast, blocks that constitute the menu control system 100 may be dispersedly implemented in two or more devices. For example, the input unit 110, the storage unit 150, and the detection unit 120 among the blocks constituting the menu control system 100 may be included in a control device (not illustrated) such as a remote controller, and the execution unit 130 and the display unit 140 may be included in a controlled device (not illustrated) such as a digital TV. As another example, the input unit 110 may be included in the control device (not illustrated), and the storage unit 150, the detection unit 120, the execution unit 130, and the display unit 140 may be included in the controlled device (not illustrated). In the case where the blocks constituting the menu control system 100 are dispersedly implemented in two or more devices as described above, the control device may include a transmission unit (not illustrated) that transmits a user command inputted through the input unit 110 and/or results of detection from the detection unit 120 to the controlled device. The controlled device may include a receiving unit (not illustrated) receiving signals transmitted from the control device.

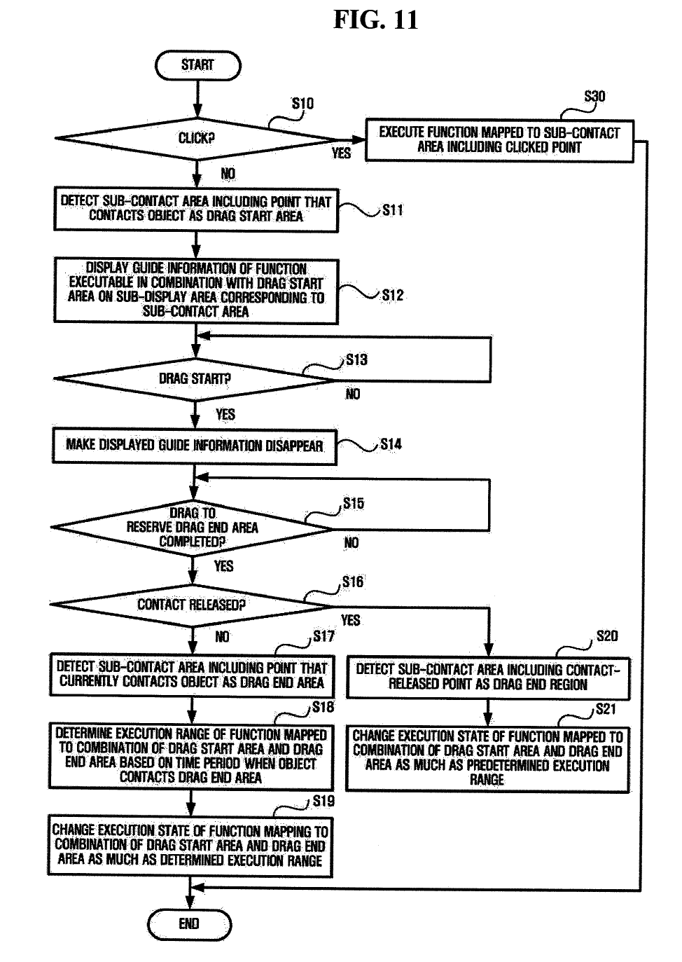

FIG. 11 is a flowchart illustrating a menu control method according to an exemplary embodiment of the present invention.

First, if an object is in contact with a contact area 400, it is judged whether the user manipulation refers to a click or a drag (S10). The term “click” means that the object becomes in contact with the contact area 400 and then the contact state is released in a predetermined time.

If the user manipulation refers to the click as a result of judgment (“Yes” at operation S10), a function mapped to the sub-contact area that includes the clicked point is executed with reference to the mapping table 500 as shown in FIG. 5 (S30).

If the user manipulation refers to the drag as a result of judgment (“No” at operation S10), the sub-contact area including the point which the object becomes in contact with is detected as the drag start area (S11).

If the drag start area is detected, guide information of functions that can be executed in combination with the drag start area is displayed on the sub-display area 600 corresponding to the sub-display area (S12). For example, if the object as shown in FIG. 4 is in contact with the third sub-contact area 430, guide information of the functions that can be executed in combination with the third sub-contact area 430 is displayed on the first sub-display area 610, the second sub-display area 620, and the fourth sub-display area 640 corresponding to the first sub-contact area 410, the second sub-contact area 420, and the fourth sub-contact area 440, respectively, as shown in FIG. 7. If the contact area 400 and the display area 600 coincide with each other, as shown in FIG. 8, the boundaries of the respective sub-contact areas may be displayed together with the guide information of the executable functions.

After the guide information of the executable functions is displayed, it is judged whether the drag of the object starts (S13). If the drag of the object starts as a result of judgment, the guide information being displayed through the respective sub-display areas 600 may disappear (S14).

Then, it is determined whether the object has been dragged to a reserve drag end area (S15). That is, it is determined whether the object is dragged to a sub-contact area except for the drag start area.

If the object is not dragged to the reserve drag end area as a result of judgment (“No” at operation S15), it is continuously detected whether the drag of the object is completed. If the object is dragged to the reserve drag end area, it is determined whether the contact state between the object and the contact area 400 is released (S16).

If it is judged that the contact state is released (“Yes” at operation S 16), the sub-contact area including the contact-released point is detected as the drag end area (S20).

When the drag end area is detected as described above, the state of the function mapping on the combination between the drag start area and the drag end area is changed as much as the predetermined range with reference to the mapping table 500 as shown in FIG. 5 (S21). Then, the graphical user interface for indicating the execution state of the corresponding function is displayed on the display area 600. At this time, the graphical user interface can be displayed on the sub-display area 600 corresponding to the sub-contact area except for the drag start area.

In contrast, if it is judged that the contact state between the object and the contact area is not released (“No” at operation S16), the sub-contact area including the point which the object is currently in contact with is detected as the drag end area (S17).

The execution range of the function mapping on the combination of the drag start area and the drag end area is determined based on the time period when the object is in contact with the drag end area (S18). For example, the execution range of the function is determined in proportion to the time period when the object is in contact with the drag end area.

When the execution range is determined as described above, the execution state of the function mapped to the combination of the drag start area and the drag end area is changed as much as the determined execution range (S19). Then, the graphical user interface indicating the execution state of the corresponding function is displayed on the display area 600.

Each element described above may be implemented as a kind of ‘module’. The term “module”, as used herein, means, but is not limited to, a software or hardware component, such as a Field Programmable Gate Array (FPGA) or an Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

With this in mind, and in addition to the above described exemplary embodiments, further exemplary embodiments of the present invention can also be implemented through computer readable code/instructions in/on a medium, e.g., a computer readable medium, to control at least one processing element to implement any of the above described exemplary embodiments. The medium can correspond to any medium/media permitting the storing and/or transmission of the computer readable code.

The computer readable code can be recorded on a medium in a variety of ways, with examples of the medium including recording media, such as magnetic storage media (e.g., ROM, floppy disks, hard disks, etc.) and optical recording media (e.g., CD-ROMs, or DVDs). Further, the computer readable code can be transmitted by transmission media such as carrier waves, as well as through the Internet, for example. Thus, the medium may further be a signal, such as a resultant signal or a bitstream, according to exemplary embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

As described above, according to an exemplary embodiment of the present invention, functions of a digital device can be controlled easily and promptly without disturbing content viewing/listening.

Although the present invention has been described in connection with the exemplary embodiments of the present invention with reference to the accompanying drawings, it will be apparent to those skilled in the art that various modifications and changes may be made thereto without departing from the scope and spirit of the invention. Therefore, it should be understood that the above embodiments are not limitative, but illustrative in all aspects.

What is claimed is:

1. A menu control system comprising:
a detection unit which detects a first sub-contact area and a second sub-contact area within a contact area, the contact area generating a signal through contact with an object if the object is dragged from the first sub-contact area to the second sub-contact area; and
an execution unit which executes a function mapped to a combination of the detected first sub-contact area and second sub-contact area.

2. The menu control system of claim 1, further comprising a display unit which displays a graphical user interface which indicates an execution state of the function being executed on a display area;
wherein the display area is divided into a plurality of sub-display areas which correspond to the first sub-contact area and the second sub-contact area.

3. The menu control system of claim 2, wherein the graphical user interface is displayed on the sub-display area corresponding to the sub-contact area excepting the first sub-contact area.

4. The menu control system of claim 2, wherein when the object is in contact with the first sub-contact area, guide information of a function that is executed in combination with the second sub-contact area is displayed on the sub-display area corresponding to the second sub-contact area.

5. The menu control system of claim 1, wherein the execution unit changes an execution state of the function as much as a predetermined execution range if the object is dragged from the first sub-contact area to the second sub-contact area.

6. The menu control system of claim 1, wherein the execution unit changes an execution state of the function as much as an execution range determined in accordance with a dragging speed of the object from the first sub-contact area to the second sub-contact area.

7. The menu control system of claim 1, wherein the execution unit changes an execution state of the function as much as a predetermined execution range in proportion to a time period when the object is in contact with the second sub-contact area.

8. The menu control system of claim 1, wherein the function related to content playback includes at least one of a volume adjustment, a screen brightness adjustment, a screen size adjustment, a scroll position adjustment, a cursor position adjustment, a playback speed adjustment, and a channel adjustment.

9. A menu control system comprising:
a detection unit which detects a first sub-contact area and a second sub-contact area within a contact area, the contact area generating a signal through contact with an object if the object is dragged from the first sub-contact area to the second sub-contact area; and
a communication unit which provides a command corresponding to a combination of contact with the detected first sub-contact area and second sub-contact area to a digital device.

10. A menu control system comprising:
a communication unit which receives a command mapped to a combination of a first sub-contact area and a second sub-contact area within a contact area, the contact area generating a signal through contact with an object if the object is dragged from the first sub-contact area to the second sub-contact area; and
an execution unit which executes a function corresponding to the received command.

11. A menu control method comprising:
detecting a first sub-contact area and a second sub-contact area within a contact area, the contact area generating a signal through contact with an object if the object is dragged from the first sub-contact area to the second sub-contact area; and
executing a function mapped to a combination of the detected first sub-contact area and second sub-contact area.

12. The menu control method of claim 11, further comprising:
displaying a graphical user interface which indicates an execution state of the function being executed on a display area;
wherein the display area is divided into a plurality of sub-display areas to correspond to the first sub-contact area and the second sub-contact area.

13. The menu control method of claim 12, wherein the displaying comprises: displaying the graphical user interface on the sub-display area corresponding to the sub-contact area except for the first sub-contact area.

14. The menu control method of claim 12, wherein the displaying comprises: displaying guide information of a function that is executed in combination with the second sub-contact area on the sub-display area corresponding to the second sub-contact area when the object is in contact with the first sub-contact area.

15. The menu control method of claim 11, wherein the executing comprises: changing an execution state of the function as much as a predetermined execution range whenever the object is dragged from the first sub-contact area to the second sub-contact area.

16. The menu control method of claim 11, wherein the executing comprises: changing an execution state of the function as much as an execution range determined in accordance with the dragging speed of the object.

17. The menu control method of claim 11, wherein the executing comprises changing the execution state of the function as much as a predetermined execution range in proportion to a time period when the object is in contact with the second sub-contact area.

18. The menu control method of claim 11, wherein the function related to content playback includes at least one of a volume adjustment, a screen brightness adjustment, a screen size adjustment, a scroll position adjustment, a cursor position adjustment, a playback speed adjustment, and a channel adjustment.

19. A menu control method comprising:
detecting a first sub-contact area and a second sub-contact area within a contact area, the contact area generating a signal through contact with an object if the object is dragged from the first sub-contact area to the second sub-contact area; and
providing a command corresponding to a combination of the detected first sub-contact area and second sub-contact area to a digital device.

20. A menu control method comprising:
receiving a command mapped to a combination of a first sub-contact area and a second sub-contact area in a contact area for generating a signal through contact with an object if the object is dragged from the first sub-contact area to the second sub-contact area; and
executing a function corresponding to the received command.

21. The menu control system of claim 1, wherein the contact area further comprises a third sub-contact area and a fourth sub-contact area, and the execution unit further executes a function mapped to a combination of any two of the detected first sub-contact area, second sub-contact area, third sub-contact area and fourth sub-contact area.

22. The menu control method of claim 11, further comprising:
detecting a third sub-contact area and a fourth sub-contact area within the contact area; wherein
the executing executes a function mapped to a combination of any two of the detected first sub-contact area, second sub-contact area, third sub-contact area and fourth sub-contact area.
